(19) United States
(12) Patent Application Publication
(10) Pub. No.: US 2022/0015606 A1
(43) Pub. Date: Jan. 20, 2022

(54) STICKY MAT CHANGING DEVICE

(71) Applicant: TRIPLE WIN TECHNOLOGY(SHENZHEN) CO.LTD., Shenzhen (CN)

(72) Inventor: TIE-CHANG XIAO, Shenzhen (CN)

(21) Appl. No.: 17/375,303

(22) Filed: Jul. 14, 2021

(30) Foreign Application Priority Data
Jul. 17, 2020 (CN) 202010692978.4

(51) Int. Cl. A47L 23/26; B08B 7/00

(52) U.S. Cl. CPC A47L 23/266; B08B 7/0028; A47L 23/263

(57) ABSTRACT

A sticky mat changing device includes a frame, an unreeling roller, a reeling roller, and a control module. The frame includes a foot board configured for supporting a sticky mat. The unreeling roller is operable to unreel the sticky mat. The reeling roller is operable to reel the sticky mat. The unreeling roller and the reeling roller are disposed inside the frame and located on opposite sides of the foot board, the control module is operable to control each of the reeling roller and the unreeling roller to rotate to change a portion of the sticky mat supported on the foot board.

### FIELD

The subject matter herein generally relates to a manufacturing equipment, and more particularly to a sticky mat changing device for automatically changing a sticky mat.

### BACKGROUND

Sticky mats are generally cut into rectangular pieces and placed directly on the ground to remove foot contaminants. The user usually changes the sticky pad manually after a long time.

### BRIEF DESCRIPTION OF THE DRAWINGS

Implementations of the present technology will now be described, by way of embodiment, with reference to the attached figures.

FIG. 1 is a schematic view of an embodiment of a sticky mat changing device according to the present disclosure.

FIG. 2 is a schematic view of a frame in the sticky mat changing device of FIG. 1.

FIG. 3 is a block diagram of an embodiment of a sticky mat changing device according to the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like.

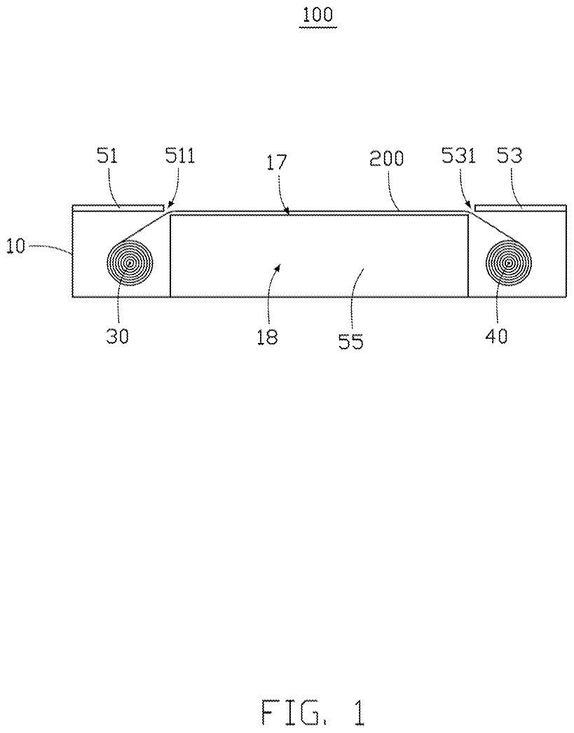

Referring to FIG. 1, a sticky mat changing device 100 is illustrated. The sticky mat changing device 100 includes a frame 10, an unreeling roller 30, and a reeling roller 40. The unreeling roller 30 is disposed on an end of the frame 10 and is configured to unreel a sticky mat 200. The reeling roller 40 is disposed on the other end of the frame 10 and is configured to reel the sticky mat 200.

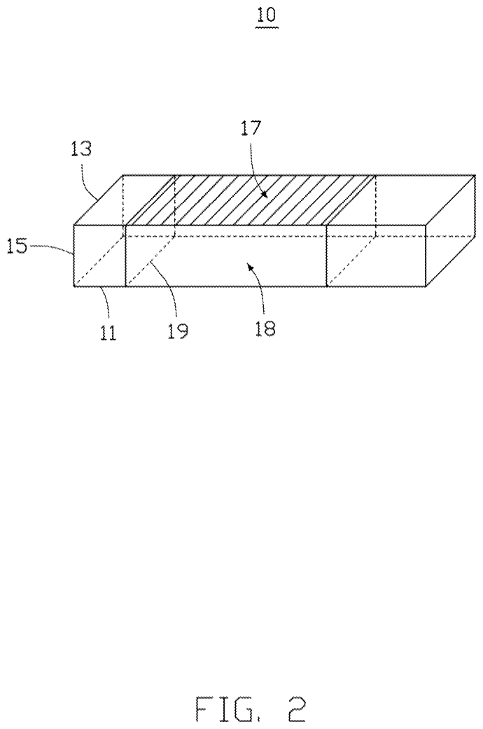

Referring to FIG. 2, the frame 10 includes a bottom frame 11, a top frame 13, a plurality of upright columns 15, and a foot board 17. Each of the bottom frame 11 and the top frame 13 is formed by four connecting rods connected in sequence. The plurality of upright columns 15 connect the bottom frame 11 and the top frame 13 to form a receiving chamber 18. In the embodiment, the frame 10 includes eight upright columns 15. Four upright columns 15 are located at the four corners of the bottom frame 11 and the top frame 13, and the other four upright columns 15 are located on opposite sides of the bottom frame 11 and the top frame 13.

The foot board 17 is disposed on the top frame 13, partially covers the top of the receiving chamber 18, and is used for the user to step on. In the embodiment, the foot board 17 includes a plurality of cross bars arranged at intervals. In other embodiments, the foot board 17 can be a whole plate.

The frame 10 further includes a plurality of reinforcing columns 19. The plurality of reinforcing columns 19 are disposed on the bottom frame 11 and connected to two sides of the bottom frame 11. In this embodiment, the frame 10 includes two reinforcing columns 19, the two reinforcing pillars 19 correspond in position to two sides of the foot board 17 respectively.

The frame 10 is made of a material with high tensile strength, such as iron, stainless steel, etc.

Referring to FIG. 1, the unreeling roller 30 is accommodated in the receiving chamber 18 and is located on one end of the frame 10. The reeling roller 40 is accommodated in the receiving chamber 18 and is located on the other end of the frame 10 facing away from the unreeling roller 30.

The sticky mat changing device 100 further includes a first cover plate 51 and the second cover plate 53. The first cover plate 51 corresponds in position to the unreeling roller 30, is disposed on the top frame 13, and partially covers the top of the receiving chamber 18. The first cover plate 51 protects the unreeling roller 30 to prevent the user from stepping on it. The first cover plate 51 is located on one side of the foot board 17. A first gap 511 is formed between the first cover plate 51 and the foot board 17 for the sticky mat 200 to pass through. The second cover plate 53 corresponds in position to the reeling roller 40, is disposed on the top frame 13, and partially covers the top of the receiving chamber 18. The second cover plate 53 protects the reeling roller 40 to prevent the user form stepping on it. The second cover plate 53 is located on a side of the foot board 17 facing away from the first cover plate 51. A second gap 531 is formed between the foot board 17 and the second cover plate 53 for the sticky mat 200 to pass through. In the embodiment, the first cover plate 51 and the second cover plate 53 are movably arranged on the top frame 13 and can be opened relative to the top frame 13. The material of the first cover 51 and the second cover 53 may be wood, iron, or the like.

The sticky mat changing device 100 further includes a third cover plate 55. The third cover plate 55 is disposed on sides of the top frame 13 and the bottom frame 11 to cover side faces of the receiving chamber 18.

When in use, the sticky mat 200 is wound on the unreeling roller 30 to form a coil stock, and one end of the sticky mat 200 passes through the first gap 511 and the second gap 531 in turn and is wound on the reeling roller 40. As a result, portion of the sticky mat 200 is exposed outside the frame 10 and supported on the foot board 17 for removing foot contaminants. When the used sticky mat 200 needs to be replaced, the unreeling roller 30 and the reeling roller 40 are rotated, and the reeling roller 40 winds up the used sticky mat 200, and the unreeling roller 30 unwinds the sticky mat, thus a portion of the unused sticky mat 200 is re-supported on the pedal 17.

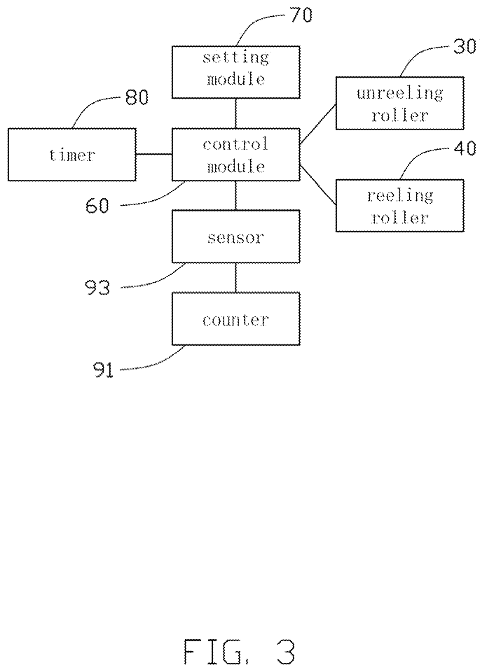

Referring to FIG. 3, the sticky mat changing device 100 further includes a control module 60. The unreeling roller 30 and the reeling roller 40 are electrically connected to the control module 60 separately. The control module 60 controls each of the unreeling roller 30 and the reeling roller 40 to rotate. The control module 60 may be a controller, a processor, a CPU, a GPU, a SoC, or a FPGA.

The sticky mat changing device 100 further includes a setting module 70. The setting module 70 sets a time interval. The setting module 70 is electrically connected to the control module 60 and controls the rotation each of the unreeling roller 30 and the reeling roller 40 according to the time interval.

The sticky mat changing device 100 further includes a timer 80. The timer 80 times a rotation interval of the unreeling roller 30 and the reeling roller 40 and starts timing when the unreeling roller 30 and the reeling roller 40 stop rotating. The timer 80 is electrically connected to the control module 60. The control module 60 controls each of the unreeling roller 30 and the reeling roller 40 to rotate when the time interval has been reached. The control module 60 controls each of the unreeling roller 30 and the reeling roller 40 to rotate for a period of time to change the portion of the sticky mat 200 supported on the foot board 17.

The setting module 70 further sets a number of stamping. The control module 60 further controls the unreeling roller 30 and the reeling roller 40 to rotate when the number of stamping has been reached.

The sticky mat changing device 100 further includes a sensor 91 and a counter 93. The sensor 91 is disposed on the foot board 17 and senses whether the foot board 17 is stepped on. The counter 93 is electrically connected to the sensor 91 and counts the number of stamping according to a sensing result from the sensor 91. The counter 93 is electrically connected to the control module 60 and controls the unreeling roller 30 and the reeling roller 40 to rotate when the number of stamping has been reached.

In the embodiment, the sensor 91 is a pressure sensor. The pressure sensor senses a pressure change on the foot board 17. The counter 93 counts the number of stamping according to the sensed pressure change. When the counted number reaches the set number of stamping, the control module 60 controls each of the unreeling roller 30 and the reeling roller 40 to rotate for a period of time to rechange the portion of the sticky mat 200 supported on the foot board 17. When the unreeling roller 30 and the reeling roller 40 stop rotating, the counter 93 restarts to count, and the control module 60 controls each of the unreeling roller 30 and the reeling roller 40 to rotate again when the counted umber reaches the set number of stamping to rechange the sticky mat 200 supported on the foot board 17 again.

In an alternative embodiment, the sensor 91 is an infrared sensor. The infrared sensor senses the number of users on the foot board 17. The counter 93 counts the number of stamping according to the sensed number of users.

In the sticky mat changing device 100, the control module 60 controls each of the unreeling roller 30 and the reeling roller 40 to rotate to automatically change the portion of the sticky mat 200 supported on the foot board 17. The work efficiency is improved and the production cost is reduced.

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure as defined by the appended claims.

What is claimed is:

1. A sticky mat changing device comprising:
a frame comprising a foot board configured for supporting a sticky mat;
an unreeling roller operable to unreel the sticky mat;
a reeling roller operable to reel the sticky mat; and
a control module;
wherein the unreeling roller and the reeling roller are disposed inside the frame and located on opposite sides of the foot board, the control module is operable to control each of the reeling roller and the unreeling roller to rotate to change a portion of the sticky mat which is supported on the foot board.

2. The sticky mat changing device of claim 1, further comprising a setting module, wherein the setting module is operable to set a time interval, the control module is electrically connected to the setting module and is operable to control the rotation each of the unreeling roller and the reeling roller according to the time interval.

3. The sticky mat changing device of claim 2, further comprising a timer, wherein the timer is operable to time a rotation interval of the unreeling roller and the reeling roller, the control module is electrically connected to the timer and is operable to control each of the unreeling roller and the reeling roller to rotate when the time interval has been reached.

4. The sticky mat changing device of claim 2, wherein the setting module is further operable to set a number of stamping, the control module is further operable to control each of the unreeling roller and the reeling roller to rotate when the number of stamping has been reached.

5. The sticky mat changing device of claim 4, further comprising a sensor and a counter, wherein the counter is electrically connected to the sensor and is operable to count the number of stamping according to a sensing result from the sensor, the control module is further operable to control each of the unreeling roller and the reeling roller to rotate when the counted number reaches the number of stamping.

6. The sticky mat changing device of claim 5, wherein the sensor is a pressure sensor or an infrared sensor.

7. The sticky mat changing device of claim 1, wherein the frame comprises a bottom frame, a top frame, and a plurality of upright columns, each of the plurality of upright columns connects the bottom frame and the top frame to form a receiving chamber, the foot board is disposed on the top frame and partially covers the receiving chamber.

8. The sticky mat changing device of claim 7, further comprising a first cover plate and a second cover plate, wherein the unreeling roller and the reeling roller are accommodated in the receiving chamber, the first cover plate corresponds in position to the unreeling roller and is disposed on the top frame, the second cover plate corresponds in position to the reeling roller and is disposed on the top frame.

9. The sticky mat changing device of claim 8, further comprising a third cover plate disposed on the top frame and the bottom frame to cover a side face of the receiving chamber.

10. The sticky mat changing device of claim 1, a material of the frame is iron or stainless steel.
